(19) United States
(12) Patent Application Publication
(10) Pub. No.: US 2020/0354654 A1
(43) Pub. Date: Nov. 12, 2020

(54) LIQUID DETERGENT COMPOSITION COMPRISING ENCAPSULATED ENZYME

(71) Applicant: E INK CORPORATION, Billerica, MA (US)

(72) Inventors: Rosa CASADO, Middleton, MA (US); Jay William ANSETH, Canton, MA (US); Jin-Gyu PARK, Lexington, MA (US); Darwin Scott BULL, Harvard, MA (US)

(21) Appl. No.: 16/851,549

(22) Filed: Apr. 17, 2020

Related U.S. Application Data
(60) Provisional application No. 62/844,924, filed on May 8, 2019.

(51) Int. Cl. C11D 3/386; C11D 17/00; C11D 11/00

(52) U.S. Cl. CPC C11D 3/38609; C11D 17/0039; C11D 3/38636; C11D 11/0017; C11D 11/0082; C11D 11/0064; C11D 3/38627

(57) ABSTRACT

Liquid detergent compositions are disclosed which comprise one or more shell-core capsules types. The core comprises one or more enzymes, wherein the material that forms the shell is able to be degraded by at least one of the enzymes. The capsules preserve the activity properties of the enzymes during the storage of the liquid detergent composition and they release the ingredients upon the application of shear during the use of the liquid detergent composition in a washing process. The methodology also enables the presence of incompatible benefit agents in the same product, and the reduction of undesirable residue on the articles that are being washed.

### RELATED APPLICATIONS

This application claims priority to U.S. Provisional Application No. 62/844,924, filed on May 8, 2019, which is incorporated herein by reference in its entirety.

### FIELD OF THE INVENTION

The present invention relates to a liquid detergent composition which comprises one or more encapsulated enzymes via shell-core capsules, wherein the encapsulation enables the immobilization of the enzyme in the liquid detergent composition and its effective release during the washing process. More specifically, in one aspect, the invention relates to a liquid detergent composition with enzymes being in the capsule core, wherein the enzyme is a protease, a carbohydrase, a lipase or mixtures thereof. In another aspect, the invention relates to a detergent composition having a shell-core capsules wherein the shell of the capsules comprises a protein, a lipid, a wax, a polysaccharide or mixtures thereof. In another aspect, the invention relates to a method of making shell-core capsules comprising a protease, a carbohydrase, a lipase or mixtures thereof in the core. In another aspect, the invention relates to a method of washing fabrics and other articles using a liquid detergent composition comprising encapsulated enzymes.

### BACKGROUND OF THE INVENTION

Enzymes are commonly used ingredients for both liquid and powder detergent compositions for cleaning fabrics and other articles. They are naturally occurring protein biocatalysts, exhibiting excellent potency in removing soils and stains from fabrics and other articles by degrading the structure of the soil and stain molecules. Degrading the structure of soils and stain molecules means that at least one of the covalent bonds of the soil and stain molecule is broken by the action of the enzyme. This degradation converts the soil and stain molecules into smaller species, resulting in easier transfer of the soil and stain from the fabrics or the other article into the wash water. Then, these smaller species are removed by draining of the wash water and then by the draining of the rinse water. However, enzymes are prone to lose their activity properties when exposed to certain harsh environments. Heavy-duty liquid detergents, which are moderately alkaline aqueous solutions or dispersions, are known to be a hostile environment for enzymes, denaturing them and, as a result, significantly reducing their activity. In addition, enzymes may be incompatible with other ingredients of liquid detergent compositions. Such incompatible ingredients may be broken down by the enzymes and/or they may irreversibly reduce the enzyme potency. It is therefore often desirable to protect the enzymes from the detergent composition during storage, yet ensure their release in a controlled and reproducible manner when the liquid detergent composition is used by the consumers. One method of protecting the enzyme is by including in the detergent composition enzyme stabilizers such as boron compounds (i.e. boric acid, borate salts) in combination with polyols (i.e. propylene glycol, glycerin). However, the potential toxicity of such additives is driving new immobilization methodologies, such as encapsulation of the enzymes. The art discloses a variety of capsules and also a variety of methodologies to trigger the release of the enzymes from the corresponding capsules during the washing process. They include release triggers such as changes in (a) ionic strength, (b) dilution, (c) temperature, (d) pH, and others. However, the existing encapsulation methodologies result in the capsule material to be practically unaffected during the washing process, which means that some of the material of the capsule is deposited on the fabrics or on the other articles as an undesirable residue, reducing the cleaning effectiveness of the liquid detergent composition. Thus, there is a need to develop liquid detergent compositions which enable (a) the preservation of the enzyme during the storage of the liquid detergent composition using capsules, (b) the efficient and rapid release of the enzyme during the washing process, and (c) the degradation of the capsule material during the washing process.

The inventors of the present invention surprisingly found that liquid detergent compositions that comprise enzyme selected from the group consisting of a protease, a carhohydrase, a lipase and mixtures thereof, wherein the enzyme is encapsulated in capsule shell comprising a protein, a lipid, a wax and/or a polysaccharide achieve these requirements.

### SUMMARY OF INVENTION

In one aspect, the various embodiments of the present invention provide a liquid detergent composition. The liquid detergent composition comprises (a) from about 90% to about 99.99% by weight of the liquid detergent composition, a continuous phase, and (b) from about 0.01% to about 10% by weight of the liquid detergent composition, shell-core capsules. The continuous phase comprises (1) from about 1% to about 50% by weight of the liquid detergent composition, one or more detersive surfactants, and (2) from about 40% to about 99% by weight of the liquid detergent composition, water. Each of the shell-core capsules comprises a shell and a core. The shell is formed by a protein, a polysaccharide, a lipid, a wax or mixtures thereof. The core comprises an effective amount of one or more enzymes selected from the group consisting of a protease, a carbohydrase, a lipase or mixtures thereof. The shell of the capsule encloses the core of the capsule. The shell of the capsule is insoluble in the continuous phase of the liquid detergent composition. The shell ruptures in the presence of shear stress generated during the agitation step of the washing process, and the shell material is degradable by the action of the one or more enzymes.

In another aspect, the various embodiments of the present invention provide a method of making a liquid detergent composition comprising shell-core capsules by (a) making shell-core capsules and (b) mixing the shell-core capsules with water and detersive surfactant. The shell-core capsules are made by (1) mixing a water-insoluble material with an effective amount of one or more enzymes selected from the group consisting of a protease; a lipase, a carbohydrase and mixtures thereof, wherein the water-insoluble material is a solid, a gel, or a liquid at room temperature, (2) separating the mixture from step 1 into particles or drops; the average size of the largest dimension of the particles or drops is from about 0.01 mm to about 5 mm, (3) coating the particles or drops by a shell to form shell-core capsules, wherein the shell is formed from a material selected from the group consisting of a protein, a polysaccharide, a lipid, a wax and mixtures thereof, and (4) mixing the shell-core capsules prepared in step (3) with a continuous phase of the liquid detergent composition, comprising water and detersive surfactant. The liquid detergent composition comprises (i) from about 90% to about 99.99% by weight of the liquid detergent composition; a continuous phase, wherein the continuous phase comprises from about 1% to about 50% by weight of the liquid detergent composition, one or more detersive surfactants, and from about 40% to about 90% by weight of the liquid detergent composition, water, and (ii) from about 0.01% to about 10% by weight of the liquid detergent composition, shell-core capsules, wherein each of the core-shell capsules comprises a shell and a core, wherein the shell is insoluble in the continuous phase of the liquid detergent composition, wherein the shell ruptures in the presence of shear stress generated during the agitation step of the washing process, and wherein the shell material is degradable by the action of the one or more enzymes.

In another aspect, the various embodiments of the present invention provide a method of washing fabrics or other articles comprising the steps of (a) providing a liquid detergent composition, comprising a continuous phase and shell-core capsules (b) combining the liquid detergent composition with water and with fabrics or other articles to be washed, (c) agitating the combination from step b, and (d) removing the wash water. The method of washing fabrics or other articles may further comprise step e, wherein step e comprises (1) adding rinse water into the washing vessel, (2) agitating the contents of the washing vessel, and (3) removing the rinse water from the washing vessel; wherein step e follows step d. The liquid detergent composition comprises from about 90% to about 99.99% by weight of the liquid detergent composition, a continuous phase, and from about 0.01% to about 10% by weight of the liquid detergent composition, shell-core capsules, wherein each of the shell-core capsules comprises a shell and a core. The continuous phase comprises from about 1% to about 50% by weight of the liquid detergent composition; one or more detersive surfactants; and from about 40% to about 99% by weight of the liquid detergent composition, water. The core of the shell-core capsules comprises (i) an effective amount of one of more enzymes selected from the group consisting of a protease, a lipase, a carbohydrase and mixtures thereof; and (ii) a water-insoluble material which is a solid; a liquid or a gel at room temperature. The shell of the shell-core capsules encloses the core of the capsule. The shell is formed from a material selected from the group consisting of a protein, a polysaccharide, a lipid, a wax and mixtures thereof. The shell is insoluble in the continuous phase of the liquid detergent composition. The shell ruptures in the presence of shear stress generated during the agitation step of the washing process. The shell material is degradable by the action of the one or more enzymes.

In another aspect of the present invention, the liquid detergent composition may comprise only one type of shell-core capsules. An example is a capsule wherein the shell is formed from a protein or a cross-linked protein and the core comprises a protease; the core may further comprise a carbohydrase, a lipase, or mixtures thereof. Another example is a capsule wherein the shell comprises a polysaccharide and the core comprises a carbohydrase; the core may further comprise a protease, a lipase, or mixtures thereof. Another example is a capsule wherein the shell comprises a lipid or a wax and the core comprises a lipase; the core may further comprise a carbohydrase, a protease, or mixtures thereof.

In another aspect of the present invention, the liquid detergent composition may comprise two or more types of shell-core capsules, a first capsule type and a second capsule type. The shell of the first capsule type may be formed from a polysaccharide and the core of the second capsule type may comprises a carbohydrase.

In another aspect of the present invention, the liquid detergent composition may comprise two or more types of shell-core capsules, a first capsule type and a second capsule type. The shell of the first capsule type may be formed from a lipid, and the core of the second type capsule may comprise a lipase. The core of the first capsule type may further comprise a carbohydrase, and the shell of the second capsule type may be formed from a polysaccharide.

In another aspect of the present invention, the liquid detergent composition may comprise two or more types of shell-core capsules, a first capsule type and a second type capsule. The shell of the first capsule type may be formed from a protein or a cross-linked protein and the core of the second capsule type may comprise a protease. The core of the first capsule type may further comprise a carbohydrase (or a lipase), and the shell of the second capsule type may be formed from a polysaccharide (or a lipid).

In another aspect of the present invention, the liquid detergent composition may comprise three or more types of shell-core capsules, a first capsule type, a second capsule type and a third capsule type, wherein the shell of the first capsule type may be formed from a protein or cross-linked protein, the shell of the second capsule type may be formed from a polysaccharide and the shell of the third capsule type may be formed from a lipid or a wax.

### BRIEF DESCRIPTION OF DRAWINGS

FIG. 1 of the accompanying drawings is an illustration of an example of a shell-core capsule that can be used in the liquid detergent composition of the present invention, wherein the shell comprises an enzyme.

FIGS. 2 and 3 are illustrations of two different types of shell-core capsules; the core of each capsule comprises a different class of enzymes, wherein both types of capsules are present in the same liquid detergent composition.

FIG. 4 is an illustration of an example of a shell-core capsule wherein the core comprises an enzyme and an additional benefit agent, which is not enzyme.

FIG. 5 is an illustration of two different types of shell-core capsules; the core of one type of capsule comprises an enzyme, whereas the core of the other type of capsule comprises a benefit agent, which is not enzyme. Both types of capsules are present in the same liquid detergent composition.

FIGS. 6a, 6b and 6c is an illustration of an example of the process of making shell-core capsules.

### DETAILED DESCRIPTION

Liquid detergent compositions are disclosed which comprise shell-core capsules comprising one or more enzymes in their core and a material that forms the shell, wherein the material that forms the shell is degradable by the one or more enzymes. The capsules preserve the activity properties of the enzymes during the storage of the liquid detergent composition and they rupture in the presence of shear stress generated during the agitation step of the washing process. The shell of the shell-core capsules is degradable by the one or more enzymes. The methodology enables a storage-stable product, a fast release and activation of the enzymes during the washing process, and the presence of incompatible benefit agents in the liquid detergent composition.

The term “protein”, as used herein, includes polymers comprising at least 2 amino acid units connected by a peptide bond. That is, the term “protein”, as used herein, includes dipeptides and oligopeptides. The term also includes crosslinked proteins. Proteases are enzymes that degrade peptide bonds of proteins to convert the proteins to smaller molecules.

The term “polysaccharide”, as used herein, includes polymers and oligomers comprising at least 2 monosaccharide units connected to each other. In this respect the term also includes disaccharides, comprising two monosaccharide units, oligosaccharides, comprising 3 to 10 monosaccharide units, and polysaccharides, comprising more than 10 monosaccharide units. Carbohydrases are enzymes that degrade polysaccharides to smaller molecules.

The term “carbohydrase”, as used herein, includes any enzyme that catalyzes the breakdown of polysaccharides (as defined above), into smaller species. A carbohydrase, also called glycosidase, can be any specialized enzyme that breakdown polysaccharides, such as amylase, invertase, glucoamylase, and other enzymes that breakdown carbohydrates.

The term “lipid” is defined herein as a substance belonging to the group of fat and fat-like substances that are insoluble in water and extractable by nonpolar solvents such as ether, chloroform, hydrocarbon solvents, or benzene. Lipids include unsaturated and saturated fatty acids, saturated and unsaturated fatty esters, saturated and unsaturated fatty alcohols, saturated and unsaturated fatty amines and ammonium salts, non-volatile hydrocarbon liquids and waxes, steroids, phospholipids, and other fatty materials. Typical molecular weight of lipids is from about 100 to about 10000 g/mole. Lipases are enzymes that degrade lipids to smaller molecules.

As used herein, a “solid” is a material that has a definite volume and shape and it resists forces that tend to alter its volume and shape. As used herein, a “liquid” is a material that can flow and conforms to the shape of a confining vessel, but it is relatively incompressible. The term “liquid”, as used herein, also includes semisolids, which are materials that are in between a solid and a liquid. A typical examples of a semisolid is a liquid having high viscosity. As used herein, a “gel” is a two-phase system composed of a solid network phase swollen by a liquid phase. Gels are colloids in which the liquid medium has become viscous enough to behave more or less as a solid. Thus, gels may be elastic and jellylike or solid and rigid. The particles of the solid network in a gel are typically too small to be seen in an ordinary optical microscope.

“Effective amount” means an amount of a compound or composition sufficient to significantly induce a positive benefit.

“Insoluble” compound or material in a solvent or a composition means that less than 0.1 g of the compound or material dissolves in 1 L of the solvent or the composition, at 25° C. and 1 atmosphere of pressure. This means that a material is insoluble in the liquid detergent composition if the material has solubility that is lower than 0.1 g in 1 L of the liquid detergent composition at 25° C. and 1 atmosphere of pressure. Similarly, a material is insoluble in water if the material has solubility that is lower than 0.1 g in 1 L of distilled water at 25° C. and 1 atmosphere of pressure.

The term “molecular weight” or “MW” as used herein refers to the number average molecular weight unless otherwise stated. The number average molecular weight may be measured by gel permeation chromatography.

All percentages used herein represent percent weight content by weight of the total composition, unless otherwise designated.

Liquid Detergent Composition

The present invention relates to a liquid detergent composition. Liquid detergent compositions are typically used to clean fabrics and other articles in washing machines and related devices, although washing “by hand” is also practiced in many parts of the world. Liquid detergent compositions may be liquids, gels or pastes. They are sold as aqueous solutions or dispersions packaged in drums, bottles, uni-dose packages or other containers. They are differentiated from solid detergent compositions that are sold in the more traditional powder form or as dissolvable solid articles.

Liquid detergent compositions typically comprise aqueous solutions of detersive surfactants. Detersive surfactants are, by far, the most commonly used cleaning materials. Such surfactants can be anionic, nonionic, amphoteric, zwitterionic, cationic or mixtures thereof. Detersive surfactants are capable of reducing the surface tension of water, a feature that provides their ability to remove dirt from fabrics and other articles. The most common detersive surfactants are synthetic compounds made from petroleum-based or naturally-based starting materials. Naturally-existing biosurfactants are also available, but their use in commercial detergent compositions is rare because of their high cost.

The liquid detergent composition of the present invention comprises a continuous phase. The continuous phase comprises from about 1% to about 50% by weight of the liquid detergent composition, one or more detersive surfactants, and from about 40% to about 99% by weight of the liquid detergent composition, water. The liquid detergent composition of the present invention may comprise from about 10% to about 40% by weight of the liquid detergent composition, one or more detersive surfactants, or from about 15% to about 35% by weight of the liquid detergent composition, one or more detersive surfactants. The liquid detergent composition may comprise from about 60% to about 90% by weight of the liquid detergent composition, water, or from about 65% to about 85% by weight of the liquid detergent composition, water.

The liquid detergent composition has a pH value of about 4 to about 12. The liquid detergent composition may have a pH value of about 6 to about 10.

Other ingredients that are commonly used in liquid detergent compositions include perfumes, bleaching agents or other oxidation agents, bleach activators, lather or suds boosters, lather or suds suppressors, anticorrosion agents, soil suspending agents or dispersants, soil release agents, dyes, bluing agents, optical brighteners, fillers, anti-microbial agents, fabric softening agents, pH controlling agents, hydrotropes, chelating agents and other ingredients.

Enzyme Capsules

The liquid detergent composition comprises capsules, wherein the capsule comprises a core and a shell and wherein the shell encloses the core.

The liquid detergent composition comprises from about 0.01% to about 10% by weight of the liquid detergent composition, capsules. The liquid detergent composition may comprise from about 0.05% to about 5% by weight of the liquid detergent composition, capsules. The liquid detergent composition may comprise from about 0.1 to about 1% by weight of the liquid detergent composition, capsules.

The capsules in the liquid detergent composition may have average diameter of from about 0.1 mm to about 5 mm. The capsules may have average diameter in the range of from about 0.5 mm to about 5 mm. The capsules may have average diameter in the range of from about 1 mm to about 4 mm.

The shell of the capsules in the liquid detergent composition may have average thickness of from about 0.1 μm to about 100 μm. The shell of the capsules may have average thickness of from about 1 μm to about 50 μm. The shell of the capsules may have average thickness from about 4 μm to about 20 μm.

The shell content of the shell-core capsule is from about 2% to about 40% by weight of the shell-core capsule or from about 4% to about 30% by weight of the shell-core capsule, or form about 8% to about 25% by weight of the shell-core capsule.

The shell of the capsule is formed from a material selected from the group consisting of proteins, polysaccharides, lipids, waxes, and mixtures thereof.

The proteins, polysaccharides, lipids, and waxes that are appropriate for forming the capsule shell of the liquid detergent composition of the present invention must be insoluble in the continuous phase of the liquid detergent composition. The shell may be formed from a material that is naturally-occurring or synthetic. The material may include a protein, a cross-linked protein, a polysaccharides, a modified polysaccharide, a lipid, an organic wax, another polymer such as an acrylate, a polyester, and other. The material may also include mixtures thereof. Non-limiting examples include zein, casein, albumin, gelatin, gum, cellulose, functionalized cellulose, chitosan and derivatives, and natural wax.

The shell encapsulates an effective amount of one or more enzymes, wherein the enzyme is selected from the group consisting of proteases, lipases, carbohydrase and mixtures thereof.

The capsule core that comprises the effective amount of the enzyme also comprises one or more water-insoluble materials. The water-insoluble material can be one or more hydrophobic oils or waxes. Non-limited examples of hydrophobic oils and waxes include hydrocarbons, glyceride esters of fatty acid, other fatty acid esters, fatty amides, fatty acids, fatty alcohols, silicone oils, and other hydrophobic materials. The capsule core may also comprise a thickening agent to increase the viscosity of the mixture of the water-insoluble material and the enzyme. The fact that the core of the capsule is practically an anhydrous environment may contribute to the long term stability of the enzyme inside the capsule. Non-limited examples of thickening agents for hydrophobic oils are polymeric thickening agents, such as stearic acid, 12-hydroxystearic acid, sorbitan monostearate, sorbitan monopalmitate, sucrose stearate, polyester homopolymers or copolymers, castor oil derivatives, such as hydrogenated castor oil, or solids, such as waxes, clays, organoclays and silica. The core of the shell-core material may be shear thinning, which may facilitate the rupture of the capsule during the washing process.

The fact that the protease, lipase and carbohydrase enzymes effectively degrade proteins, lipids, oils, fats, waxes and polysaccharides, contributes to their ability to remove soils and stains from fabrics and other articles. A significant part of typical soils and stains in dirty fabrics and other articles consist of proteins, lipids, oils, fats, waxes and polysaccharides. The degradation of soils and stains molecules makes them more soluble or dispersible in the wash water inside the washing machine, facilitating their removal from the item to be cleaned by the wash water and by the rinse water.

The soil and stain removal ability of the liquid detergent composition that comprises an enzyme requires the preservation of the chemical and conformational structure of the enzyme from the time the liquid detergent composition is manufactured until the time it is used by the consumer for cleansing. Thus, it is important that the enzyme's activity properties are protected during this period. It is generally known that enzymes are prone to lose their activity properties when exposed to harsh environments, such as in the moderately alkaline aqueous heavy-duty liquid detergents. In such environments, many useful enzymes become denatured and their ability to degrade other molecules is significantly reduced. Many detergent manufacturers stabilize enzymes in liquid detergent compositions by including enzyme stabilizers, such as boron compounds (i.e. boric acid or borate salts) typically in combination with polyols, such as propylene glycol and glycerin. However, the toxicity of those additives makes this technical approach less desirable and other technical approaches, such as encapsulation of the enzyme, are being used.

As mentioned above, it is important that the enzyme is protected during the storage of the liquid detergent composition. This, in turn, requires that the capsule is not soluble or permeable by water in the environment of the liquid detergent composition. In addition, the contents of the core of the capsule must not leak out of the capsule into the continuous phase of the liquid detergent composition during storage.

The integrity of the capsule in the liquid detergent composition during its storage can be preserved by the choice of the shell material, the average thickness and the average diameter of the capsules. Cross-linking of the shell materials may improve the capsule integrity. This cross-linking can be physical (non-covalent interactions between molecules) or chemical (formation of intermolecular covalent bonds). For example, in the case of proteins, cross-linking with bifunctional reagents such as glutaraldehyde, formaldehyde or other di-aldehydes improves the integrity of the capsule under storage. Typically, larger average size of capsules, larger average thickness and higher cross-linking show improved integrity of the capsule in the liquid detergent composition.

As mentioned above, various methodologies are used in the art to trigger the release of the enzymes from the corresponding capsules during the washing process. They include changes in (a) ionic strength, (b) dilution with water, (c) temperature, (d) pH, and others. However, such triggering mechanisms do not affect the material of the shell, which can deposit on the fabrics and other articles which are being washed, leaving an undesirable residue on them, which makes the washing less effective.

The present invention solves this problem because the material of the capsule shell will be degraded by the encapsulated enzyme after the enzyme is released into the wash water. Thus, the enzyme will not only contribute to the degradation and removal of the soils and stains from the fabrics and the other articles, but also it will contribute to the degradation and removal of the shell material. As a result, the washing process becomes more effective, as a reduced residue from the capsule shell will be available to be deposited on the fabrics and the other articles.

Another benefit from the invention is the rapid and efficient release of the enzymes from the capsules during the washing process. The capsules will initially release at least some of the encapsulated enzyme because a number of them will rupture from the increased shear stress produced during the agitation step of the washing process from the movement of the articles that are being washed. However, because of the capsule composition, the release will be effective even if this rupture is incomplete and not all the capsules become ruptured by the shear stress. A small initial release from the shear stress-induced rupture may be sufficient to trigger some enzyme release into the wash water, which may trigger additional capsules to be degraded, releasing their contents. This is the result of the fact that the material of the capsule shell is degradable by the enzyme after the enzyme is released into the wash water. A person skilled in the art understands that, given the fact that enzymatic reactions are fast and specific and they do not consume the biocatalyst, the small quantity of the initially released enzyme will cause a rapid degradation of the corresponding shell material of numerous capsule shells, which may have survived the shear stress-induced rupture, releasing more enzyme into the wash water and accelerating the process of the enzyme release. The process can be described as resembling an autocatalytic process.

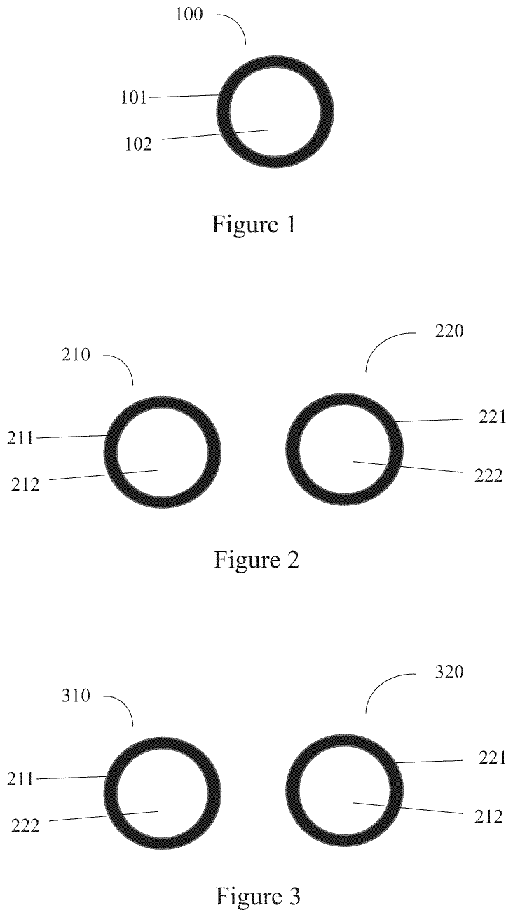

The liquid detergent composition may comprise only one type of shell-core capsules. FIG. 1 of the accompanying drawings is an illustration of an example of such a scenario, wherein the capsule shell 100 comprises shell 101, and the capsule core 102 comprises an enzyme (and a water-insoluble material), which is able to degrade the material of shell 101, A specific example is a capsule, wherein shell 101 is made from a protein and the core 102 comprises a protease. Core 102 in this example may also comprise a carbohydrase, a lipase, or mixtures thereof. Core 102 may be a solid, a viscous liquid or a gel.

Another example is a capsule wherein shell 101 is formed by a polysaccharide and core 102 comprises a carbohydrase; core 102 may further comprise a protease, a lipase, or mixtures thereof. Another example is a capsule wherein shell 101 is formed from a lipid and core 102 comprises a lipase; core 102 may further comprise a carbohydrase, a protease, or mixtures thereof. Core 102 may be a solid, a viscous liquid or a gel.

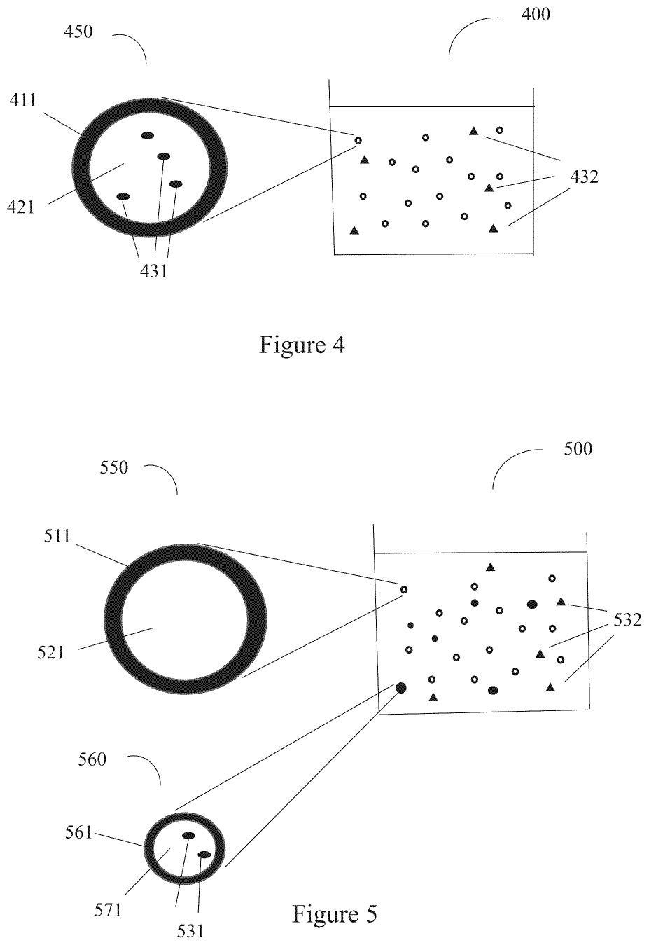

The liquid detergent composition may comprise two or more types of shell-core capsules. One example of a liquid detergent composition that comprise two types of capsules is illustrated in FIG. 2, The corresponding liquid detergent composition comprises a first capsule type 210 and a second capsule type 220. Shell 211 of the first capsule type 210 is made from material S1; core 212 of the first capsule type 210 comprises enzyme E1, which is able to degrade material S1 of shell 211 of the first capsule type 210. Core 211 of the first capsule type 210 may be a solid, a viscous liquid or a gel. Shell 221 of the second capsule type 220 is formed from material S2, which is different from material S1. Core 222 of the second capsule type 220 comprises enzyme E2, which is different from enzyme E1, and which is able to degrade material S2 of shell 211 of the second capsule type 220. Core 222 of the second capsule type 220 may be a solid, a viscous liquid or a gel. In an example of this scenario, S1 is a protein and E1 is a protease, whereas S2 is a polysaccharide and E2 is a carbohydrase.

Another example of a liquid detergent composition that comprises two types of capsules is illustrated in FIG. 3. The corresponding liquid detergent composition comprises a first capsule type 310 and a second capsule type 320. Shell 211 of the first capsule type 310 is formed from material S2; core 222 of the first capsule type 310 comprises enzyme E1. Core 222 of the first capsule type 310 may be a solid, a liquid or a gel. Shell 221 of the second capsule type 320 comprises material S1 and core 212 of the second capsule type 320 comprises enzyme E2. Core 212 of the second capsule type 320 may be a solid, a liquid or a gel. Enzyme E1 (in core 222 of the first capsule type 310) is able to degrade material S1 (material of shell 221 of the second capsule type 320). Also, enzyme E2 (in the core 212 of the second capsule type 320) is able to degrade material S2 (material of shell 211 of the first capsule type 310). In an example of this scenario, S1 is a protein and E1 is a protease; whereas S2 is a polysaccharide and E2 is a carbohydrase. The shear stress-induced rupture of at least some capsules will cause release of at least some of the enzyme molecules (E1, E2) into the wash water. This may accelerate the rupture of more capsules 310 and 320, if needed. It will also degrade the proteins and the polysaccharides of the shells so that less of these materials is available to be deposited onto the fabrics and the other articles that are being washed. It is easy to understand that in a similar scenarios, comprising multiple types of capsules in a liquid detergent composition, only one type of the capsules may need to be ruptured by shear stress to be able to release all the encapsulated enzyme of all the capsule types.

The time required to release the initial effective amount of the enzyme via the shear stress generated by the washing process can be controlled by the average diameter of the capsules and/or the average shell thickness of the capsules. Typically, larger average diameter capsules having smaller average shell thickness will be opened more rapidly by the shear applied on the capsule.

The rupture of the capsules via the shear stress generated during the agitation step of the washing process may become more favorable by controlling the mechanical properties of the capsule shell. Ideally, the capsules should remain intact during the transportation and storage of the liquid detergent composition at zero (or very low shear rates). Then, under higher shear (washing process), at least some of the capsules should rupture. The shell may rupture in the presence of a force that is larger than 100 mN or in the presence of a force that is larger than 500 mN, or in the presence of a force that is larger than 1,000 mN or in the presence of a force that is larger than 10,000 mN. The shell may also rupture in the presence of a force that causes more than 8% elongation of any one of its dimensions.

The composition of the present invention may contain capsules comprising (a) a shell made from protein or cross-linked protein and (b) a core comprising a protease in a water-insoluble oil, which is thickened by hydrogenated castor oil. The oil may be a terpene, such as limonene.

The composition of the present invention may contain two types of capsules A and B. Capsule A may comprise (a) a shell made from protein or cross-linked protein and (b) a core comprising a polysaccharide in a water-insoluble oil, which is thickened by hydrogenated castor oil. Capsule B may comprise (a) a shell made from polysaccharide or cross-linked polysaccharide and (b) a core comprising a protease in a water-insoluble oil, which is thickened by hydrogenated castor. The oil may be a terpene such as limonene.

The composition of a capsule core of the liquid detergent composition may comprise one or more additional benefit agents or other ingredient, other than an enzyme, such as an oxidation agent, a dye, a whitening agent, a chelant, a builder, a perfume, an anti-microbial agent, a fabric softening agent, a pH control agent, or other benefit agent.

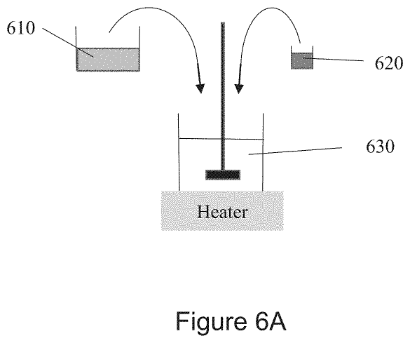

The inclusion of the one or more additional benefit agents (other than enzymes) in the capsule core may be especially useful in cases where there are ingredients that are incompatible with each other and at least one of them would be degraded or would become inactivated during the storage of the product. An example is illustrated in FIG. 4. If benefit agent 431 and benefit agent 432 are incompatible, inclusion of 431 in the core of the capsules and inclusion of 432 in the continuous phase of the liquid detergent composition 400 will mitigate the incompatibility problem. In the example of FIG. 4, capsule shell 411 of capsule 450 is formed from material S1. Core 421 comprises enzyme E1 and benefit agent 431. Benefit agent 432, which is incompatible with benefit agent 431, is included in the continuous phase of the liquid detergent composition 400. The shear stress generated in the agitation step of the washing process will release E1 and 431 from the shell-core capsule 450 into the continuous phase of the liquid detergent composition 400. This will enable the degradation of material S1 of shell 411 and the benefit action of benefit agent 431. This methodology enables the use of incompatible benefits agents 431 and 432 in the same product without the detrimental interaction between the two benefit agents during the storage of the product.

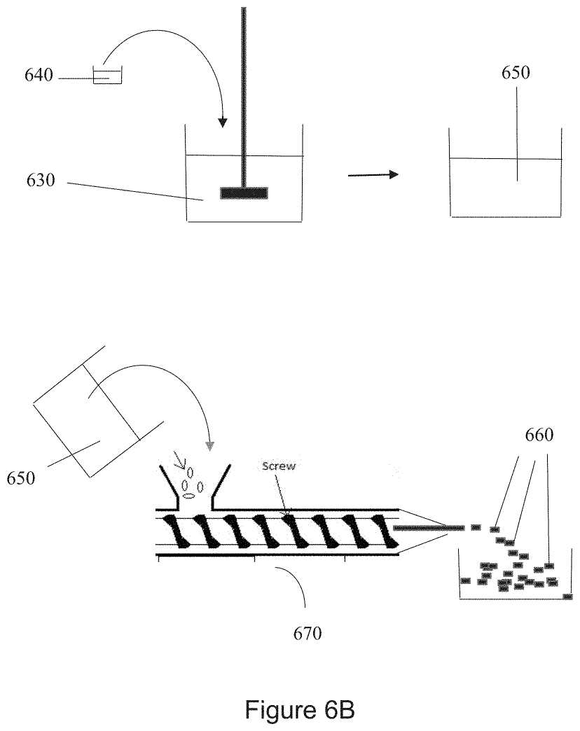

The additional incompatible benefit agents may be either included (a) in the core of the capsules which contains the enzyme, as described in the previous paragraph, or (b) they may be included in the core of separate capsules, which do not contain any enzymes. An example of the later scenario is illustrated in FIG. 5. The liquid detergent composition 500 of the example comprises two capsule types, a first capsule type 550 and a second capsule type 560. Shell 511 of the first capsule type 550 is formed from material S1, and core 521 of the first capsule type 511 comprises enzyme E1. Shell 561 of the second capsule type 560 is formed from material S1 and core 571 of the second capsule type 560 comprises benefit agent 531, which is incompatible with benefit agent 532, which is included in the continuous phase of the liquid detergent composition 500. Enzyme E1 is able to degrade the material of shell 511 of capsule type 550 and the material of shell 561 of capsule type 560. In this scenario, the desirable outcomes (protection of enzyme E1 and benefit agent 531 during storage, release of the enzyme E1 and benefit agent 531 during the washing process, and degradation of the materials of shell 511 and 561) are possible, even if the second capsule type 560 is not ruptured from the shear stress generated during the agitation step of the washing process. This is viable because the released enzyme E1 from the first capsule type 550 may be able to degrade shell 561 of the second capsule type 560 and to rupture it via the degradation mechanism. In another example that can also be represented by FIG. 5, shell 511 of the first capsule type 550 is formed from material S1, and core 521 of the first capsule type 511 comprises enzyme E2. Shell 561 of the second capsule type 560 is formed from material S2 and core 571 of the second capsule type 560 comprises benefit agent 531 and enzyme E2. Benefit agent 531 may be with benefit agent 532, which is included in the continuous phase of the liquid detergent composition 500. Enzyme E1 is able to degrade the material of shell 511 of capsule type 550 and enzyme E2 is able to degrade the material of shell 561 of capsule type 560. In this scenario, the desirable outcomes (protection of enzymes E1, E2, and benefit agent 531 during storage, release of the enzymes E1, E2 and benefit agent 531 during the washing process, and degradation of the materials of shell 511 and 561) are possible.

Method of Washing Fabrics and Other Articles

In another aspect, the various embodiments of the present invention provide a method of washing fabrics or other articles comprising the steps of (a) providing a liquid detergent composition, comprising a continuous phase and shell-core capsules (b) combining the liquid detergent composition with water and with fabrics or other articles to be washed, (c) agitating the combination from step b, and (d) removing the wash water. The method of washing fabrics or other articles may further comprise step e, wherein step e comprises (1) adding rinse water into the washing vessel, (2) agitating the contents of the washing vessel, and (3) removing the rinse water from the washing vessel, wherein step e follows step d. The liquid detergent composition comprises from about 90% to about 99.99% by weight of the liquid detergent composition, a continuous phase, and from about 0.01% to about 10% by weight of the liquid detergent composition, shell-core capsules, wherein each of the shell-core capsules comprises a shell and a core. The continuous phase comprises from about 1% to about 50% by weight of the liquid detergent composition, one or more detersive surfactants; and from about 40% to about 99% by weight of the liquid detergent composition, water. The core of the shell-core capsules comprises (i) an effective amount of one of more enzymes selected from the group consisting of a protease, a lipase, a carbohydrase and mixtures thereof, and (ii) a water-insoluble material which is a solid, a liquid or a gel at room temperature. The shell of the shell-core capsules encloses the core of the capsule. The shell is formed from a material selected from the group consisting of a protein, a polysaccharide, a lipid, a wax and mixtures thereof. The shell is insoluble in the continuous phase of the liquid detergent composition. The shell ruptures in the presence of shear stress generated during the agitation step of the washing process. The shell material is degradable by the action of the one or more enzymes.

Process of Making Enzyme Capsules

The enzyme capsules of the present invention comprise a core having an enzyme and a water-insoluble material. The enzyme is typically mixed in a high speed mixer at room temperature or at an elevated temperature with the water-insoluble material. If needed, a thickening agent is also added. The resulting mixture, which is a solid or a liquid or a gel at room temperature, is then distributed into particles (or drops) of the desired size. The particles or drops may have average size of the largest dimension of the particle or drop of about 0.01 mm to about 5 mm, or from about 0.1 mm to about 5 mm. An extruded equipped with a knife or other appropriate equipment may be used for this step. The particles (or drops) are then coated with the material that serves as a shell. This step can be performed by precipitating the shell material on the particles. Various processes may be used for this step such as (a) treating the particles with a solution of the shell material and evaporating the solvent, (b) treating the particles with a solution of the shell material and then with a medium in which the shell material is insoluble, (c) treating the particles with a solution of the shell material and then adding a complexing agent that precipitates the shell material, (d) spraying the particles with a melt of the shell material, (d) precipitating the shell material in a dispersion of the particles by polymerization or copolymerization, (e) or other relevant methodology that is known in the art.

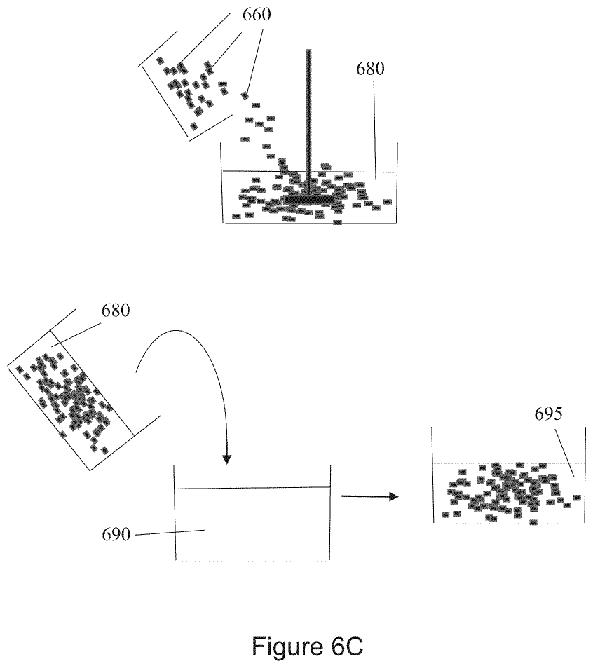

An example of the encapsulation process is provided below for making protease capsule using a shell that contains protein. The example includes three main steps (a) gel precursor preparation, (b) gel making and pelleting, and (c) encapsulation of the enzyme pellets. FIGS. 6A, 6B, and 6C provide schematic descriptions that correspond to the three main steps. In the first step, a water-insoluble material 610 and a thickening agent are mixed in a container to prepare a gel precursor 630 as shown in FIG. 6A. Gel precursor 630 is mixed with enzyme (or enzyme solution) 640 to form enzyme gel 650. Enzyme gel 650 is extruded using extruder 670. At the orifice of the extruder, enzyme pellets 660 are collected, as shown in FIG. 6B. Enzyme pellets 660 are combined under agitation with a polymer solution 630, such as a protein solution in propylene glycol, to form a dispersion of enzyme pellets in protein solution 680. Finally, the dispersion of enzyme pellets in protein solution 680 is mixed with water to form a water dispersion of shell-core capsules 695, as shown in FIG. 6C. The formed dispersion of shell-core capsules 695 can be added into a continuous phase of a detergent to form a liquid detergent composition (step not shown).

### Example of a Process of Making Enzyme Capsules

An amount of 9.6 g of limonene (supplied by Florida Chemical Company, Winter Haven, Fla.), was mixed with 0.8 g of hydrogenated castor oil (Thixcin R®, supplied by Elements Specialties, East Windsor, N.J.) at 10,000 rpm for 10 minutes at a temperature of 60° C. using an IKA Ultra-Turrax. Into this solution, an amount of 0.08 g of solid protease (Protamex®, supplied by Millipore-Sigma; P0029), was added and mixed for 2 minutes under the same conditions. While the above mixture was still fluid, it was extruded into a rod of approximately 3 mm in diameter using a single-screw extruder. The rod was cooled at room temperature providing a gel structure, which was cut into pellets each of which had approximate size of 4 mm. The mechanical properties of a pellet were tested by applying a force of 0.2 N. The pellet maintained its physical form, while the pellet broke by applying a force of 4 N.

A water insoluble shell was deposited on the above pellets using the following process: A solution of Zein (supplied by Millipore-Sigma; W555025) in propylene glycol (supplied by Aldrich; 81380) was made by mixing 98 g of propylene glycol with 2 g of Zein and vigorously mixed at room temperature for 3 minutes using a high speed mixer. The gel pellets were dipped into the Zein-propylene glycol solution, followed by transferring to a beaker containing 100 mL of water, which caused the precipitation of the Zein protein on the enzyme pellets and preparing shell-core capsules.

Evaluation of the Film Properties of Cross-Linked Zein Protein

The evaluation described in the following two paragraphs was performed to determine if the film properties of a cross-linked protein material are appropriate for use as shell in enzyme capsules for a liquid detergent composition. A solution of 3 g of Zein in 60 g of ethanol/Water (80/20 wt %) was added into a Petri dish and allowed to dry at room temperature. The film, which has a thickness of approximately 150μ, was cross-linked by the addition of 450 μL of a 50% aqueous solution of glutaraldehyde and placed on a hot plate set at 50° C. for 2 hours. The insolubility of the glutaraldehyde-cross-linked Zein film was tested by immersing the film (approximate size of 1 cm²) into a vial containing 20 ml of Orange House Laundry Detergent Liquid (Yuen Foong Yu Consumer Products Co., LTD) and placed in an oven at 45° C. After 7 days the film was still present in the vial.

The degradability of the cross-linked Zein film was tested by placing approximately 0.03 g of the film into a vial containing 10 mL of wash water (250 ppm water hardness, pH=8.6), 0.05 g of Orange House Laundry Detergent Liquid (Yuen Foong YU Consumer Products Co., LTD), and 0.05 g of solid protease (Protamex®, supplied by Millipore-Sigma; P0029). The vial was mixed at room temperature in an orbital mixer and the integrity of the film was visually monitored over time. It was observed that the film was reduced in size over time. After 210 minutes no film remained in the solution indicating that the whole film was disintegrated. A control sample was run in parallel having the same composition but without the protease. In that case the film remained intact.

The elongation at Break of a zein protein film is 9% measured via ASTM D-882.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

Wash water is the liquid mixture that is present at the washing vessel during the end of the agitation process in the presence of the liquid detergent composition.

Unless otherwise noted, all component or composition levels are in reference to the active portion of that component or composition, and are exclusive of impurities, for example, residual solvents or by-products, which may be present in commercially available sources of such components or compositions.

What is claimed is:

1. A liquid detergent composition comprising:
a. from about 90% to about 99.99% by weight of the liquid detergent composition, a continuous phase comprising:
(1) from about 1% to about 50% by weight of the liquid detergent composition, one or more detersive surfactants; and
(2) from about 40% to about 99% by weight of the liquid detergent composition, water;
b. from about 0.01% to about 10% by weight of the liquid detergent composition, shell-core capsules, wherein each of the shell-core capsules comprises a shell and a core,
(1) the core comprising:
(a) an effective amount of one of more enzymes selected from the group consisting of a protease, a lipase, a carbohydrase and mixtures thereof; and
(b) a water-insoluble material which is a solid, a liquid, or a gel at room temperature;
(2) the shell is formed from a material selected from the group consisting of a protein, a polysaccharide, a lipid, a wax and mixtures thereof, wherein the shell encloses the core, wherein the shell is insoluble in the continuous phase of the liquid detergent composition, and wherein the shell ruptures in the presence of shear stress generated during the agitation step of the washing process, and wherein the shell material is degradable by the action of the one or more enzymes.

2. The liquid detergent composition according to claim 1, wherein the continuous phase further comprises at least one benefit agent other than the one or more detersive surfactants.

3. The liquid detergent composition according to claim 2, wherein the at least one benefit agent other than the one more detersive surfactants is selected from an oxidation agent, a dye, a whitening agent, a chelant, a builder, a perfume, an anti-microbial agent a fabric softening agent, and a pH control agent.

4. The liquid detergent composition according to claim 1, wherein the core further comprises at least one benefit agent other than the one or more enzymes.

5. The liquid detergent composition according to claim 4, wherein the at least one benefit agent other than the one more enzymes is selected from an oxidation agent, a dye, a whitening agent, a chelant, a builder, a perfume, an anti-microbial agent a fabric softening agent, and a pH control agent.

6. The liquid detergent composition according to claim 1, wherein the shell ruptures in the presence of a force that is larger than 100 mN.

7. The liquid detergent composition according to claim 1, wherein the core further comprises a thickening agent.

8. The liquid detergent composition according to claim 1, wherein the shell content of the shell-core capsule is from about 2% to about 40% by weight of the shell-core capsule.

9. The liquid detergent composition according to claim 1, wherein the liquid detergent composition comprises two or more shell-core capsule types, a first capsule type and a second capsule type, wherein the shell of the first capsule type is formed from a polysaccharide, and wherein the core of the second type capsule comprise a carbohydrase.

10. The liquid detergent composition according to claim 1, wherein the liquid detergent composition comprises two or more shell-core capsule types, a first capsule type and a second capsule type, wherein the shell of the first capsule type is formed from a lipid, and wherein the core of the second type capsule comprise a lipase.

11. The liquid detergent composition according to claim 10, wherein the core of the first capsule type further comprises a carbohydrase, and the shell of the second capsule type is formed from a polysaccharide.

12. The liquid detergent composition according to claim 1, wherein the liquid detergent composition comprises two or more shell-core capsule types, a first capsule type and a second capsule type, wherein the shell of the first capsule type is formed from a protein, and wherein the core of the second type capsule comprise a protease.

13. The liquid detergent composition according to claim 12, wherein the core of the first capsule type further comprises a carbohydrase, and the shell of the second capsule type is formed from a polysaccharide.

14. The liquid detergent composition according to claim 12, wherein the core of the first capsule type further comprises a lipase, and the shell of the second capsule type is formed from a lipid.

15. The liquid detergent composition according to claim 1, wherein the liquid detergent composition comprises three shell-core capsule types, a first capsule type, a second capsule type and a third capsule type, wherein the shell of the first capsule type comprises a protein, the shell of the second capsule type comprises a polysaccharide and the shell of the third capsule type comprises a lipid.

16. The liquid detergent composition according to claim 1, wherein the shell-core capsules have average diameter of from about 0.1 mm to about 5 mm.

17. The liquid detergent composition according to claim 1, wherein the shell of the shell-core capsule have average thickness of from about 0.1 μm to about 100 μm.

18. A method of washing fabrics and other articles using a detergent composition comprising the steps:
a. Providing a liquid detergent composition comprising:
(1) from about 90% to about 99.99% by weight of the liquid detergent composition, a continuous phase comprising:
(a) from about 1% to about 50% by weight of the liquid detergent composition, one or more detersive surfactants; and
(b) from about 40% to about 99% by weight of the liquid detergent composition, water;
(2) from about 0.01% to about 10% by weight of the liquid detergent composition; shell-core capsules, wherein each of the shell-core capsules comprises a shell and a core,
(a) the core comprising:
i. an effective amount of one of more enzymes selected from the group consisting of a protease, a lipase, a carbohydrase and mixtures thereof; and
ii. a water-insoluble material which is a solid, a liquid or a gel at room temperature;
(b) the shell is formed from a material selected from the group consisting of a protein, a polysaccharide, a lipid, a wax and mixtures thereof, wherein the shell encloses the core, wherein the shell is insoluble in the continuous phase of the liquid detergent composition; wherein the shell ruptures in the presence of shear stress generated during the agitation step of the washing process, and wherein the shell material is degradable by the action of the one or more enzymes;
b. combining the liquid detergent composition with water and with fabrics or other articles to be washed into a washing container;
c. agitating the combination from step b; and
d. removing the wash water from the washing container.

19. The method of washing fabrics and other articles according to claim 17, wherein the method further comprises step e, wherein step e comprises (1) adding rinse water into the washing vessel; (2) agitating the contents of the washing vessel, and (3) removing the rinse water from the washing vessel, wherein step e follows step d.

20. A method of making a liquid detergent composition comprising the steps:
a. Making shell-core capsules by
(1) mixing a water-insoluble material with an effective amount of one or more enzymes selected from the group consisting of a protease, a lipase, a carbohydrase and mixtures thereof, wherein the water-insoluble material is a solid, a liquid or a gel at room temperature;
(2) separating the mixture from step (1) into particles having average size of the particles' largest dimension of from about 0.01 mm to about 5 mm;
(3) coating the particles by a shell material to form shell-core capsules, the shell comprising a material selected from the group consisting of a protein, a polysaccharide; a lipid, a wax and mixtures thereof;
b. Mixing the shell-core capsules prepared in step a with water and detersive surfactant;
wherein the liquid detergent composition comprises (i) from about 90% to about 99.99% by weight of the liquid detergent composition, a continuous phase, wherein the continuous phase comprises from about 1% to about 50% by weight of the liquid detergent composition, one or more detersive surfactants, and from about 40% to about 90% by weight of the liquid detergent composition, water, and (ii) from about 0.01% to about 10% by weight of the liquid detergent composition, shell-core capsules, wherein each of the core-shell capsules comprise a shell and a core, wherein the shell is insoluble in the continuous phase of the liquid detergent composition, wherein the shell ruptures in the presence of shear stress generated during the agitation step of the washing process, and wherein the shell material is degradable by the action of the one or more enzymes.
